(19) United States
(12) Patent Application Publication
(10) Pub. No.: US 2025/0373990 A1
(43) Pub. Date: Dec. 4, 2025

(54) HEARING AID COMPRISING A TARGET QUALITY ASSESSMENT UNIT

(71) Applicant: Oticon A/S, Smørum (DK)

(72) Inventors: Jesper JENSEN, Smørum (DK); Svend FELDT, Smørum (DK); Michael Syskind PEDERSEN, Smørum (DK)

(21) Appl. No.: 19/215,369

(22) Filed: May 22, 2025

(30) Foreign Application Priority Data
May 29, 2024 (EP) 24178887.6

(51) Int. Cl. H04R 25/00

(52) U.S. Cl. CPC H04R 25/507; H04R 25/40; H04R 2225/43

(57) ABSTRACT

Disclosed herein are embodiments of a hearing aid. The hearing aid can include an input unit configured to provide an electrical audio input signal representing a sound, a signal processing unit configured to provide a processed signal based on the electrical audio input signal using a first processing parameter, and a target quality assessment unit configured to determine an assessment value based on the processed signal. The signal processing can be is configured to determine an output signal based on the assessment value.

### CROSS REFERENCE TO RELATED APPLICATIONS

Any and all application for which a foreign or domestic priority claim is identified in the Application Data Sheet as filed with the present application are hereby incorporated by reference under 37 CFR 1.57.

### TECHNICAL FIELD

The present disclosure relates to the field of hearing aids comprising a signal processing unit used to produce at least one enhanced target signal, and a target quality assessment unit.

### BACKGROUND

Many signal processing systems (including hearing aid systems) rely on a voice activity detection (VAD) algorithm, applied to the input signal. The generally noisy microphone signals are used as inputs to a VAD algorithm, which determines if (and to which extent) the input signal contains speech. In simple signal processing systems, the output of the VAD algorithm is a binary value that describes if the most recent part of the input signal contains speech or not-often, this is done in a time-frequency domain, i.e., based on the output of an analysis filter bank (AFB) so that the VAD decision is made for each time-frequency tile. In more advanced signal processing systems, the output of the VAD is continuous in the range [0;1] describing a probability of speech presence.

Many hearing aid systems comprising signal processing algorithms make use of these voice activity decisions including (but not limited to) beamforming algorithms, noise reduction algorithms, sound source localization algorithms, auditory scene analysis algorithms, etc. Often, these algorithms update their parameters, i.e., internal estimates of noise and speech statistics, when the VAD algorithm declares speech to be absent and present, respectively.

While the standard configuration of signal processing systems works well in many cases, issues may arise during use of the signal processing systems. For example, these issues may include:
a) When the signal processing system comprises noise reduction algorithms, the residual noise in the enhanced target signal may be under-suppressed, leading to a noisy output signal. In other words, the speech intelligibility and quality are less than what it could have been.
b) When the signal processing system comprises noise reduction algorithms, the output signal may be over-suppressed, i.e., much of the noise may have been removed, but parts of the target signal have been removed too. This leads to reduction in speech intelligibility and quality.
c) When the signal processing system comprises algorithms which can introduce fast gain fluctuations (for example, single-channel noise reduction algorithms), the output signal may contain fast (unnatural) modulations, which were not present in the input signal. This leads to reduced quality and potentially reduced intelligibility.
d) When the signal processing system comprises beamforming algorithms, the beamformer may be mis-steered, leading to an output signal with a degraded target signal and lesser suppressed residual noise signal. Altogether, this can cause the speech intelligibility and quality to be less than what it could have been compared to a correctly steered beamformer.

Often, problem b) and c) are solved by constraining the signal processing system, e.g., to disallow fast and large signal suppressions. However, this leads to an “over-cautious” system, which—in a noise reduction context—would lead to output signals where noise is under-suppressed, i.e. Problem a).

In summary, the conventional VAD-driven speech signal processing approach, can lead to output signals which do not resemble clean (noise-free) speech signals, either because they include residual noise or because they have been distorted due to processing.

### SUMMARY

In an aspect of the present disclosure a hearing aid is provided. The hearing aid may comprise an input unit configured to provide an electrical audio input signal representing a sound. The hearing aid may comprise a plurality of first beamformers configured to provide a plurality of first beamformed signals based on the electrical audio input signal. Each of the first beamformers may is configured to be steered towards different fixed directions. Each of the first beamformers may be associated with a different first processing parameter. The hearing aid may comprise a second beamformer configured to provide a second beamformed signal based on the electrical audio input signal and a second processing parameter. A directionality of the second beamformed signal may be determined to maximize an assessment value. The hearing aid may comprise a target quality assessment function configured to determine a plurality of assessment values based on the plurality of first beamformed signals and the second beamformed signal. The hearing aid may comprise a modification unit configured to modify the second processing parameter based on the assessment values. The hearing aid may comprise an output unit configured to output an output signal determined based on a modified second processing parameter.

Thereby an improved hearing aid may be provided.

In the present disclosure, sound may be used to describe an acoustic signal of an environment. The sound may comprise a target sound. The sound may comprise a noise sound. The sound may comprise the target sound and the noise sound. The sound may be a combination of the target sound and the noise sound and may be referred to as a mixture sound. The target sound may be provided by a target sound source. The target sound source may comprise a human or a transducer or an acoustic emitter or a musical instrument. Typically, the target sound is speech and provided by a human. The target sound may be provided by a plurality of target sound sources. The noise sound may be provided by a noise sound source. The noise sound source may comprise a human or a transducer or an acoustic emitter or reflections of sound. The noise sound may be provided by a plurality of noise sound sources. The target sound and noise sound may be provided by different sound sources.

The target sound may be characterized as one or more of the following sound types: speech, music, alarms, notification sounds, voice keywords, and tones. The noise sound may be characterized as one or more of the following sound types: speech, music, alarms, tones, sound artifacts such as microphone noise and quantization noise, room reverberation, feedback, transient sounds, echoes, wind noise, and ambient sounds. The noise sound may be a combination of said sound types.

An input unit may comprise an input transducer. The input transducer may comprise a microphone configured to pick-up sound. The input unit may be configured to provide the electrical input signal based on the sound picked up. The input transducer may comprise an antenna to pick-up a wireless signal representing sound. The input transducer may comprise an accelerometer configured to pick-up vibrations or movements representing sound. The input transducer may provide an input transducer output. The input unit may comprise a plurality of input transducers. The plurality of input transducers may comprise a combination of one or more of following: a microphone, an antenna, and an accelerometer.

The input unit provides an electrical audio input signal. The electrical audio input signal may be based on an input transducer output. The electrical audio input signal may be based on a plurality of input transducer outputs. The electrical audio input signal may be an electrical representation of the sound. The electrical audio input signal may comprise a target signal and a noise signal. The target signal may represent the target sound. The noise signal may represent the noise sound.

The electrical audio input signal may be a time-domain representation of the sound. The electrical audio input signal may be a time-frequency domain representation of the sound.

The hearing aid may comprise a signal processing unit. The signal processing unit may be configured to receive a signal processing input signal based on the electrical audio input signal. The signal processing unit may be configured to provide a processed signal. The processed signal may be the target signal amplified relative to the noise signal, e.g., by noise reduction, feedback control, beamforming, dereverberation, etc. The processed signal may be the noise signal attenuated relative to the target signal. The signal processing unit may be configured to provide a plurality of processed signals. The signal processing unit may be configured to process the signal processing input signal by filtering, applying gains, and/or utilizing machine learning algorithms to thereby provide the processed signal, or to provide a plurality of processed signals.

The signal processing input signal may be the electrical audio input signal, or a processed version of the electrical audio input signal.

The term ‘processed signal’ may be understood as the signal processing input signal having undergone processing. Processing may comprise amplification, filtering, beamforming, i.e., arithmetic operations performed on the signal. Processing may constitute a signal processing algorithm. The signal processing algorithm may apply processing to the signal processing input signal. The signal processing algorithm may include an analysis filter bank, a synthesis filter bank, a noise reduction algorithm, a hearing loss compensation algorithm, a feedback cancellation algorithm, etc.

The signal processing unit may provide a plurality of processed signals. The signal processing unit may provide a processed signal for each output of signal processing algorithms constituting the signal processing unit.

The signal processing unit may use the first processing parameter to provide the processed signal. The signal processing unit may use the first processing parameter to provide a plurality of processed signals. The first processing parameter may be used by a signal processing algorithm. The signal processing unit may apply the first processing parameter to the signal processing input signal to thereby provide the processing signal or the plurality of processed signals. The first processing parameter may be one or more filter weights, one or more gains, or audio processing parameters. Each of the plurality of first beamformers may have a unique first processing parameters associated with them.

The target quality assessment unit may be configured to provide an assessment value based on the processed signal. The target quality assessment unit may be configured to provide an assessment value based on the processed signal. The target quality assessment unit may be configured to provide an assessment value based on a plurality of processed signals. The target quality assessment unit may be a voice activity detector or other detectors for determining an audio parameter. The target quality assessment unit may be configured to determine the audio parameter. The target quality assessment unit may be configured to provide an assessment value based on the electrical audio input signal. The target quality assessment unit may be configured to determine an assessment value for each of the plurality of first beamformed signals and the second beamformed signal.

The assessment value may be understood as a value that quantifies the perceptual quality or the signal quality or intelligibility of the processed signal. The assessment value may be understood as a value that quantifies the perceptual quality or the signal quality of the plurality of processed signals. The assessment value may be determined by an algorithm. The assessment value may be a MOS score, a STOI score, a PESQ score, a voice activity detection value, signal-to-noise ratio (SNR), segmental SNR, scale-invariant SNR, estimated mean squared error, or other quality parameters, or approximation or estimations thereof. The assessment value may be a speech probability score. The assessment value may be an audio parameter determined by the target quality assessment unit. The assessment value may be based on an audio parameter determined by the target quality assessment unit.

The audio parameter may be based on a MOS score, a STOI score, a PESQ score, a voice activity detection value, or other quality parameters.

The target quality assessment unit may be based on a function which models the human preference of speech. The assessment value may be a value which is indicative of a human preference of speech.

The output signal may be the output of the signal processing unit. The output signal may be based on the processed signal and the assessment value. The output signal may be a combination of the processed signal and the electrical audio input signal. A modified first processing parameter may be determined based on the assessment value, where the signal processing unit is configured to provide the output signal based on the electrical audio input signal using the modified first processing parameter. The assessment value may be used to modify one or more first processing parameters. The assessment value may be used to determine mixing of the processed signal and the electrical audio input signal.

The hearing aid may be configured to determine the output signal based on a modified second beamformed signal. The modified second beamformed signal may be determined by utilizing the modified second processing parameter in the second beamformer.

The output signal may be a signal to be provided to a user of the hearing aid. The output signal may be a signal to be transmitted to another device communicatively connected to the hearing aid.

The output unit may comprise an output transducer. The output transducer may comprise a loudspeaker, e.g. a hearing aid receiver. The output unit may receive an output unit input signal. The output unit input signal may be the output signal of the signal processing unit. The output unit may comprise a transmitter for transmitting the output signal to another device communicatively connected to the hearing aid.

In an embodiment the plurality of first beamformers are minimum power distortion-less response beamformers or minimum variance distortion-less response beamformers.

In an embodiment the second beamformer is a beamformer where the cost function of the beamformer is configured to determine the beamformer weights to optimize for the assessment value.

In an embodiment, the hearing aid comprises a second processing parameter and determines a modified second processing parameter based on the determined assessment values. The second processing parameter may be used by the signal processing unit to provide the processed signal to be output. A modification unit may determine the modified second processing parameter by using an optimizer to minimize a cost function. The modified second processing parameter may be determined based on the first processing parameter and the assessment value. The output signal may be determined based on the modified second processing parameter.

In one example, one or more of the at least one assessment value is a binary value. In another example, one or more of the at least one assessment value is a value between ‘0’ and ‘1’ wherein an assessment value of ‘1’ or close to ‘1’ may indicate a high assessment performance an assessment value of ‘0’ or close ‘0’ may indicate a low assessment performance.

Thereby, an advantage of the present disclosure is a hearing aid with improved speech enhancement by determining an output signal based on the assessment value.

An audio parameter may comprise one or more of the following: a speech-likeness value, a speech intelligibility value, a voice activity value, a speech quality value.

The speech intelligibility value may be a numerical value quantifying the speech intelligibility of the processed signal. The speech intelligibility value may be based on the short-term objective intelligibility (STOI) score, the extended short-term objective intelligibility (ESTOI), spectro-temporal glimpsing index (STGI). The speech intelligibility value may be determined by predictors of the short-term objective intelligibility (STOI) score or predictors of the extended short-term objective intelligibility (ESTOI). The predictors may comprise a machine learning method configured to predict the speech intelligibility score in question.

The speech quality value may be a numerical value quantifying the speech quality of the processed signal. The speech quality value may be based on the PESQ score or POLQA score. The speech quality value may be determined by predictors of the PESQ score or predictors of the POLQA score. The predictors may comprise a machine learning method.

The voice activity value may be a numerical value quantifying the presence of speech in the processed signal. The voice activity value may be a numerical value quantifying the presence of voice-only in the processed signal. The voice activity value may be determined based a conventional voice activity detection algorithm. The voice activity value may be based on signal-to-noise ratio. The voice activity value may be a numerical value quantifying the probability of speech presence.

The speech-likeness value may be a numerical value quantifying the degree of speech resemblance of the processed signal. The numerical value may be a value between 0 and 1. The degree of speech resemblance may be determined using a speech model. The degree of speech resemblance may be determined using a trained neural network configured to determine the degree of speech resemblance.

The audio parameter may comprise a combination of several parameters. For example, the audio parameter may comprise a combination of one or more of the following parameters: a speech-likeness value, an intelligibility value, a voice activity value, a speech quality.

The assessment value may be the audio parameter. The assessment value may be a processed version of the audio parameter. If the audio parameter comprises several parameters, the assessment value may be a combination of those parameters, e.g., a weighted combination.

In an embodiment, the assessment value is the audio parameter or the combination of audio parameters.

The hearing aid may comprise a signal extraction unit. The hearing aid may comprise a plurality of filters using a plurality of first processing parameters. The hearing aid may comprise a plurality of filters using a plurality of first processing parameters and a second processing parameter. The filters may be configured to determine a plurality of processed signals. The target quality assessment unit may be configured to determine a plurality of assessment values based on the plurality of processed signals. The output signal may be based on selecting one of the processed signals from the plurality of processed signals based on the plurality of assessment values. The output signal may be based on selecting a subset of the processed signals from the plurality of processed signals based on the plurality of assessment values, and combine the processed signals from the subset to provide the processed signal. The combination may be a linear combination wherein the weights may be determined based on the assessment values.

The output signal may be based on the processed signal with the highest assessment value.

The plurality of filters may be configured to extract a target from the electrical input signal. The plurality of filters may each constitute or form part of a forward signal processing path in the hearing aid. The plurality of filters may differ from each other. Each of the plurality of filters may be configured to provide a processed signal by processing the signal processing input signal. The plurality of processed signals provided by the plurality of filters may differ from each other. Each filter may comprise one or more of the following: a beamformer, a single-channel filter, or a trained neural network trained to attenuate noise or enhance the target in the input signal of the neural network. The filters may be constituted by a plurality of first beamformers and a second beamformer.

Each of the plurality of processed signals may be considered as a candidate for selection as the output signal. Each of the plurality of processed signal may be considered as a candidate speech signal.

The plurality of first processing parameters may differ from each other. The plurality of first processing parameters and the second processing parameter may differ from each other. Each of the first processing parameters of the plurality of first processing parameter may be associated with a first beamformer, and the second processing parameter may be associated with a second beamformer. Each of the first processing parameters and the second processing parameter may comprise one or more beamformer weights, one or more single-channel filter weights, and/or one or more weights of a trained neural network.

The target quality assessment unit may be configured to determine an assessment value for each of the plurality of processed signals determined by the plurality of filters.

The hearing aid may be configured to rank the processed signals according to their assessment value. The hearing aid may be configured to select the highest ranking processed signal as the output signal. The hearing aid may be configured to select a subset of the highest ranking processed signals and combine them to provide the output signal. For example, each assessment value may be determined based on one of the processed signals. The assessment value may be a voice activity value indicative presence of speech.

The signal extraction unit may be configured to attenuate a noise signal representing the noise sound from the electrical audio input signal. The signal extraction may be configured to extract the target signal representing the target sound from the electrical audio input signal. The signal extraction unit may comprise the plurality of filters. The beamformer weights may determine a plurality of beamformer characteristics of the beamformer. The beamformer characteristics may include the steering direction, beampattern, white noise gain, directivity, etc. of the beamformer. The processed signal may be determined as a linear combination using the beamformer weights. The signal extraction unit may comprise a plurality of beamformers where each beamformer may use a plurality of beamformer weights. The single-channel filter may comprise at least one single-channel filter weight determining the frequency response of the single-channel filter. The signal processing unit may use the single-channel filter to modify the frequency response of the signal extraction unit input signal. The beamformer may comprise the single-channel filter.

The beamformer may comprise a delay-and-sum beamformer, or a cancelling beamformer, or a minimum variance distortion less response (MVDR) beamformer, or a minimum power distortion-less response (MPDR) beamformer, or a linear constrained minimum variance (LCMV) beamformer, or the multichannel Wiener filter (MWF) beamformer. The single-channel filter may be a filter based on the Wiener filter or spectral subtraction.

The beamformer may be the generalized sidelobe canceller (GSC) structure beamformer. The first processing parameter may be a real-value or complex value.

The trained neural network may comprise a convolutional neural network, or feedforward neural networks, or multi-layer perceptrons, or recurrent neural network, or transformer networks comprising the plurality of filters.

The hearing aid may comprise a modification unit. The modification unit may be configured to determine a modified second processing parameter by modifying the second processing parameter based on the assessment value. The hearing aid being configured to determine the output signal using the modified second processing parameter. For example, the modified second processing parameter may be used to process the electrical audio input signal to determine the output signal.

The modification unit may comprise an optimizer configured to determine the modified second processing parameter. The modification unit may receive the assessment value. If a plurality of assessment values has been determined the modification unit may receive the plurality of assessment values. The modification unit may receive the first processing parameters and the second processing parameter. The modification unit may determine the modified first parameter based on the one or more received assessment values, the first processing parameters, and the second processing parameter.

The optimizer may comprise a gradient descent or ascent algorithm using a learning rate. The learning rate is used to determine the adaptation rate of the gradient descent algorithm. The learning rate may be a pre-defined value chosen by the manufacturer or a hearing aid care professional. The learning rate may be a function of the speech likeness measure (e.g. decreasing learning rates for high speech likeness). The learning rate may be a function of the development of the speech likeness measure across time, e.g., its gradient (e.g. decreasing learning rates when speech likeness saturates). The gradient descent algorithm may receive the first processing parameters, the second processing parameter, learning rate and assessment values, and determine the modified second processing parameter.

In an embodiment, the modification unit comprises a gradient descent algorithm using a pre-defined learning rate. The modification unit receives the assessment values, the first processing parameters and the second processing parameter. The modification unit determines a step-direction based on the assessment values. The modification unit determines the modified second processing parameter by combining the learning rate, the step-direction, the first processing parameters, and the second processing parameter.

In an embodiment, the signal processing unit determines the output signal based on the second modified parameter. The modification unit may replace the second processing parameter with the modified second parameter. The modification unit may replace the second processing parameter with the modified second parameter, and the hearing aid may determine the output signal based on the modified second processing parameter.

Thereby, an advantage of the present disclosure is to use a modification unit to modify the first processing parameter for improved speech intelligibility and sound quality.

The target quality assessment unit may be configured to provide a plurality of assessment values. The target quality assessment unit may provide a total assessment value based on the assessment values. The modification unit may be configured to modify the processing parameters based on the total assessment value.

The total assessment value may be a combination of the assessment values. The combination may be a linear combination of assessment values using at least one assessment value weight. The at least one assessment value weight may be pre-defined by the manufacturer or a hearing aid care professional.

Thereby, an advantage of the present disclosure is the use of a total assessment value which combines multiple assessment values to determine the output signal with improved speech intelligibility and sound quality.

The modification unit (MOD) may be configured to modify the second processing parameter based on a derivative of a binary cross entropy cost function.

The binary cross entropy cost function may be used as the cost function for the optimizer. The binary cross entropy cost function may determine a cost based on the assessment value or the total assessment value. The cost may be based on a plurality of assessment values or of the total assessment value. The derivative of the binary cross entropy cost function may be determined by computing the partial derivative of the binary cross entropy cost function with respect to the first processing parameter.

The optimizer may comprise a backpropagation algorithm for computing the partial derivative of the first processing parameter.

Thereby, an advantage of the present disclosure is the use of an optimizer to modify the first parameter to determine the output signal with improved speech intelligibility and sound quality.

The modification unit may comprise a gradient descent algorithm to modify the second processing parameter.

The hearing aid may comprise a voice activity unit. The voice activity unit may be configured to determine the presence or absence of a speech signal based on the electrical audio input signal. The voice activity unit may provide a voice activity signal. The modification unit may be configured to modify the processing parameter based on the voice activity signal.

The voice activity unit may comprise a conventional voice activity detection algorithm. The voice activity unit may receive a voice activity unit input signal. The voice activity unit input signal may be the electrical audio input signal. The voice activity unit may provide the voice activity signal. The voice activity signal may comprise a value between ‘0’ and ‘1’ indicative of the presence of speech where a value of ‘0’ indicates speech absence and a value of ‘1’ indicates speech presence. The voice activity signal may comprise a value between ‘0’ and ‘1’ indicative of the presence of a noise-only situation where a value of ‘1’ indicates noise-only. The noise-only situation may be defined the absence of speech or modulated sounds in the sound signal. The voice activity signal may be interpreted as a probability value of speech presence or noise-only. The speech signal may be the target signal.

The modification unit use the voice activity signal to control the modification of the second processing parameter. The voice activity signal may be used to control the adaptation rate of the optimizer. The learning rate may be based on the voice activity signal. For example, the learning rate may be a scaled version of the voice activity signal. For example, the learning rate decreases for high assessment values. For example, the learning rate decreases when assessment values saturate (i.e. learning rate is anti-proportional to absolute value of gradient (with respect to time) of assessment values.

Thereby, an advantage of the present disclosure is the voice activity signal to control the adaptation of the modification unit to determine the output signal with improved speech intelligibility and sound quality.

The voice activity unit may compare the voice activity signal with a first threshold. The voice activity unit may provide a voice detection control signal.

The first threshold may be a pre-defined value determined by the manufacturer or a hearing aid care professional. The voice activity unit may use the voice activity signal and the first threshold to provide the voice detection control signal. If the voice activity signal is larger than the first threshold, the voice detection control signal indicates the presence of speech or noise-only. The voice detection control signal may then be equal to ‘1’. If the voice activity signal is smaller than or equal to the first threshold, the voice detection control signal indicates the absence of speech or noise-only. The voice detection control signal may then be equal to ‘0’.

The voice detection control signal may be used to determine the partial derivative of the binary cross entropy cost function with respect to the first processing parameter and/or the second processing parameter. The voice detection control signal may be used as a training label for the optimizer.

Thereby, an advantage of the present disclosure is the voice detection control signal to control the adaptation of the modification unit to determine the output signal with improved speech intelligibility and sound quality.

The hearing aid may comprise an output unit for providing a stimulus perceived by the user as an acoustic signal based on a processed electric signal. The output unit may a vibrator of a bone conducting hearing aid. The output unit may comprise an output transducer. The output transducer may comprise a receiver (loudspeaker) for providing the stimulus as an acoustic signal to the user (e.g. in an acoustic (air conduction based) hearing aid). The output transducer may comprise a vibrator for providing the stimulus as mechanical vibration of a skull bone to the user (e.g. in a bone-attached or bone-anchored hearing aid). The output unit may (additionally or alternatively) comprise a (e.g. wireless) transmitter for transmitting sound picked up-by the hearing aid to another device, e.g. a far-end communication partner (e.g. via a network, e.g. in a telephone mode of operation, or in a headset configuration).

The hearing aid may comprise an input unit for providing an electric input signal representing sound. The input unit may comprise an input transducer, e.g. a microphone, for converting an input sound to an electric input signal. The input unit may comprise a wireless receiver for receiving a wireless signal comprising or representing sound and for providing an electric input signal representing said sound.

The wireless receiver and/or transmitter may e.g. be configured to receive and/or transmit an electromagnetic signal in the radio frequency range (3 kHz to 300 GHz). The wireless receiver and/or transmitter may e.g. be configured to receive and/or transmit an electromagnetic signal in a frequency range of light (e.g. infrared light 300 GHz to 430 THz, or visible light, e.g. 430THz to 770 THz).

The hearing aid may comprise a directional microphone system adapted to spatially filter sounds from the environment, and thereby enhance a target acoustic source among a multitude of acoustic sources in the local environment of the user wearing the hearing aid. The directional system may be adapted to detect (such as adaptively detect) from which direction a particular part of the microphone signal originates. This can be achieved in various different ways as e.g. described in the prior art. In hearing aids, a microphone array beamformer is often used for spatially attenuating background noise sources. The beamformer may comprise a linear constraint minimum variance (LCMV) beamformer. Many beamformer variants can be found in literature. The minimum variance distortion-less response (MVDR) beamformer is widely used in microphone array signal processing. Ideally the MVDR beamformer keeps the signals from the target direction (also referred to as the look direction) unchanged, while attenuating sound signals from other directions maximally. The generalized sidelobe canceller (GSC) structure is an equivalent representation of the MVDR beamformer offering computational and numerical advantages over a direct implementation in its original form.

The hearing aid may comprise an analog-to-digital (AD) converter to digitize an analogue input (e.g. from an input transducer, such as a microphone) with a predefined sampling rate, e.g. 20 kHz. The hearing aids may comprise a digital-to-analog (DA) converter (i.e. a digital-to-analog converter (DAC)) to convert a digital signal to an analogue output signal, e.g. for being presented to a user via an output transducer.

The hearing aid may comprise a hearing instrument, e.g. a hearing instrument adapted for being located at the ear or fully or partially in the ear canal of a user, e.g. a headset, an earphone, an ear protection device, or a combination thereof. A hearing aid system may comprise a speakerphone (comprising a number of input transducers (e.g. a microphone array) and a number of output transducers, e.g. one or more loudspeakers, and one or more audio (and possibly video) transmitters e.g. for use in an audio conference situation), e.g. comprising a beamformer filtering unit, e.g. providing multiple beamforming capabilities.

In the present context, a hearing aid, e.g. a hearing instrument, refers to a device, which is adapted to improve, augment and/or protect the hearing capability of a user by receiving acoustic signals from the user's surroundings, generating corresponding audio signals, possibly modifying the audio signals and providing the possibly modified audio signals as audible signals to at least one of the user's ears. Such audible signals may e.g. be provided in the form of acoustic signals radiated into the user's outer ears and/or acoustic signals transferred as mechanical vibrations to the user's inner ears through the bone structure of the user's head and/or through parts of the middle ear.

The hearing aid may be configured to be worn in any known way, e.g. as a unit arranged behind the ear with a tube leading radiated acoustic signals into the ear canal or with an output transducer, e.g. a loudspeaker, arranged close to or in the ear canal, as a unit entirely or partly arranged in the pinna and/or in the ear canal, as a unit, e.g. a vibrator, attached to a fixture implanted into the skull bone, etc. The hearing aid may comprise a single unit or several units communicating (e.g. acoustically, electrically, or optically) with each other. The loudspeaker may be arranged in a housing together with other components of the hearing aid, or may be an external unit in itself (possibly in combination with a flexible guiding element, e.g. a dome-like element).

A hearing aid may be adapted to a particular user's needs, e.g. a hearing impairment. A configurable signal processing circuit of the hearing aid may be adapted to apply a frequency and level dependent compressive amplification of an input signal. A customized frequency and level dependent gain (amplification or compression) may be determined in a fitting process by a fitting system based on a user's hearing data, e.g. an audiogram, using a fitting rationale (e.g. adapted to speech). The frequency and level dependent gain may e.g. be embodied in processing parameters, e.g. uploaded to the hearing aid via an interface to a programming device (fitting system), and used by a processing algorithm executed by the configurable signal processing circuit of the hearing aid.

### BRIEF DESCRIPTION OF DRAWINGS

The aspects of the disclosure may be best understood from the following detailed description taken in conjunction with the accompanying figures. The figures are schematic and simplified for clarity, and they just show details to improve the understanding of the claims, while other details are left out. Throughout, the same reference numerals are used for identical or corresponding parts. The individual features of each aspect may each be combined with any or all features of the other aspects. These and other aspects, features and/or technical effect will be apparent from and elucidated with reference to the illustrations described hereinafter in which:

FIG. 1 shows an example of a RITE-style embodiment of a hearing aid HAD according to the present disclosure.

FIG. 2 shows an exemplary block diagram of an embodiment of a hearing aid comprising an input unit IN, a signal processing unit SPU, a target quality assessment unit TQAU, and an output unit OUT.

FIG. 3 shows an exemplary block diagram of an embodiment of a hearing aid comprising an input unit IN, a signal processing unit SPU comprising at least one of filter, a target quality assessment unit TQAU, a modification unit the selection of the filter for determining an output signal is based on a modification unit MOD, a voice activity unit VAU, and an output unit OUT.

FIG. 4 shows an exemplary illustration of beampatterns wherein the signal processing unit SPU comprises a plurality of filters as described in the embodiment of FIG. 3.

FIG. 5 shows an exemplary illustration of beampatterns wherein the signal processing unit SPU comprises an adaptive filter as described in the embodiment of FIG. 3.

FIG. 6 shows an exemplary block diagram of an embodiment a hearing aid system comprising a hearing aid HAD and an auxiliary device AUX wherein each is configured to communicate between each other. The auxiliary device comprising the target quality assessment unit TQAU.

FIG. 7 shows an exemplary block diagram of an embodiment of a hearing aid according to the present disclosure.

The figures are schematic and simplified for clarity, and they just show details which are essential to the understanding of the disclosure, while other details are left out. Throughout, the same reference signs are used for identical or corresponding parts.

Further scope of applicability of the present disclosure will become apparent from the detailed description given hereinafter. However, it should be understood that the detailed description and specific examples, while indicating preferred embodiments of the disclosure, are given by way of illustration only. Other embodiments may become apparent to those skilled in the art from the following detailed description.

### DETAILED DESCRIPTION OF EMBODIMENTS

The detailed description set forth below in connection with the appended drawings is intended as a description of various configurations. The detailed description includes specific details for the purpose of providing a thorough understanding of various concepts. However, it will be apparent to those skilled in the art that these concepts may be practiced without these specific details. Several aspects of the apparatus and methods are described by various blocks, functional units, modules, components, circuits, steps, processes, algorithms, etc. (collectively referred to as “elements”). Depending upon particular application, design constraints or other reasons, these elements may be implemented using electronic hardware, computer program, or any combination thereof.

The electronic hardware may include micro-electronic-mechanical systems (MEMS), integrated circuits (e.g. application specific), microprocessors, microcontrollers, digital signal processing units (SPUs), field programmable gate arrays (FPGAs), programmable logic devices (PLDs), gated logic, discrete hardware circuits, printed circuit boards (PCB) (e.g. flexible PCBs), and other suitable hardware configured to perform the various functionality described throughout this disclosure, e.g. sensors, e.g. for sensing and/or registering physical properties of the environment, the device, the user, etc. Computer program shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The present application relates to the field of hearing aids.

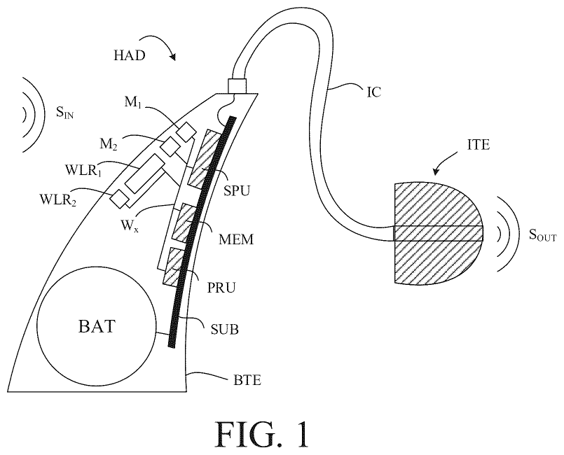

FIG. 1 shows an exemplary embodiment of a typical hearing aid HAD according to the present disclosure. The exemplary hearing aid HAD, e.g. a hearing aid, is of a particular style (sometimes termed receiver-in-the ear, or RITE, style) comprising a BTE-part BTE adapted for being located at or behind an ear of a user, and an ITE-part ITE) adapted for being located in or at an ear canal of the user's ear and comprising a receiver (loudspeaker). The BTE-part and the ITE-part are connected (e.g. electrically connected) by a connecting element IC and internal wiring in the ITE- and BTE-parts (cf. e.g. wiring Wx in the BTE-part). The connecting element may alternatively be fully or partially constituted by a wireless link between the BTE- and ITE-parts (or by an acoustic tube, if the loudspeaker is located in the BTE-part).

In the embodiment of a hearing aid in FIG. 1, the BTE part comprises an input unit comprising two (first) input transducers (e.g. microphones) M₁, M₂, each for providing an (first) electric input audio signal representative of an input sound signal SIN (originating from a sound field around the hearing aid HAD). The input unit further comprises two wireless receivers WLR₁, WLR₂ (or transceivers) for providing respective directly received auxiliary audio and/or control input signals (and/or allowing transmission of audio and/or control signals to other devices, e.g. to another hearing aid, or to a remote control or processing device. The hearing aid HAD comprises a substrate SUB whereon a number of electronic components are mounted, including a memory MEM, e.g. storing different hearing aid programs (e.g. parameter settings defining such programs, or parameters of algorithms) and/or hearing aid configurations, e.g. input source combinations M₁, M₂, WLR₁, WLR₂, e.g. optimized for a number of different listening situations. In a specific mode of operation, one or more directly received auxiliary electric signals may be used together with one or more of the electric input audio signals from the microphones to provide a spatio-temporally filtered signal provided by applying appropriate complex weights to (at least some of) the respective signals, e.g. to provide an enhanced target signal to the user (or an estimate of the user's own voice to another application, e.g. a communication partner, or a voice control interface).

The substrate SUB further comprises a configurable signal processing unit (SPU, e.g. a digital (audio) signal processing unit), e.g. including a first processor for applying a frequency and level dependent gain, e.g. providing hearing loss compensation, beamforming, noise reduction, filter bank functionality, and other digital functionality of a hearing aid. The configurable signal processing unit SPU is adapted to access the memory MEM. The substrate SUB further comprises a configurable peripheral unit PRU, e.g. including a second processor, but may in other examples be part of the first processor. The peripheral unit PRU comprises a modification unit (e.g. for modifying the memory), sound classification unit (e.g. for detecting speech presence), and a target assessment unit (e.g. for determining the enhancement performance of the signal processing unit). The configurable signal processing unit SPU and peripheral unit PRU are further configured to process one or more of the electric input audio signals and/or one or more of the directly received auxiliary audio input signals, based on a currently selected (activated) hearing aid program/parameter setting (e.g. either automatically selected, e.g. based on one or more sensors, or selected based on inputs from a user interface). The mentioned functional units (as well as other components) may be partitioned in circuits and components according to the application in question (e.g. with a view to size, power consumption, analogue vs. digital processing, acceptable latency, etc.), e.g. integrated in one or more integrated circuits, or as a combination of one or more integrated circuits and one or more separate electronic components (e.g. inductor, capacitor, etc.). The configurable signal processing unit SPU provides at least one processed signal, where at least one of the processed signals is intended to be presented to a user. The substrate further comprises a front-end IC for interfacing the configurable signal processing unit SPU to the output transducer, etc., and typically comprising interfaces between analogue and digital signals (e.g. interfaces to microphones and/or loudspeaker(s)). The input and output transducers may be individual separate components, or integrated (e.g. MEMS-based) with other electronic circuitry.

The hearing aid HAD further comprises an output unit (e.g. an output transducer) providing stimuli perceivable by the user as sound based on a processed audio signal from the processor or a signal derived therefrom. In the embodiment of a hearing aid in FIG. 1, the ITE part comprises the output transducer in the form of a loudspeaker (also termed a ‘receiver’) for converting an electric signal to an acoustic (air borne) signal, which (when the hearing aid is mounted at an ear of the user) is directed towards the ear drum (Ear drum), where sound signal Sour is provided. The ITE-part further comprises a guiding element, e.g. a dome, for guiding and positioning the ITE-part in the ear canal (Ear canal) of the user.

Apart from the (acoustic) output and input transducers, the ITE part may comprise other functional components, e.g. (further) detectors, such as electrodes for picking up signals from the user's body (such as brainwave signals, temperature indications, blood-related parameters, heartbeat indications, muscular vibrations, etc.). Such detectors may include one or more of an electroencephalography (EEG) sensor, an electromyography (EMG) sensor, a movement sensor, a temperature sensor, a photoplethysmography (PPG) sensor, an electrooculography (EOG) sensor, etc.

The electric input signals (from (first and/or second) input transducers M₁, M₂ may be processed in the time domain or in the (time-) frequency domain (or partly in the time domain and partly in the frequency domain as considered advantageous for the application in question).

The embodiments of a hearing aid HAD, e.g. a hearing aid, exemplified in FIG. 1 is a portable device comprising a battery BAT, e.g. a rechargeable battery, e.g. based on Li-Ion battery technology, e.g. for energizing electronic components of the BTE-and possibly ITE-parts. In an embodiment, the hearing aid, e.g. a hearing aid, is adapted to provide a frequency dependent gain and/or a level dependent compression and/or a transposition (with or without frequency compression) of one or more frequency ranges to one or more other frequency ranges, e.g. to compensate for a hearing impairment of a user. The BTE-part may e.g. comprise a connector (e.g. a DAI or USB connector) for connecting a ‘shoe’ with added functionality (e.g. an FM-shoe or an extra battery, etc.), or a programming device, or a charger, or a separate processing device, etc., to the hearing aid HAD.

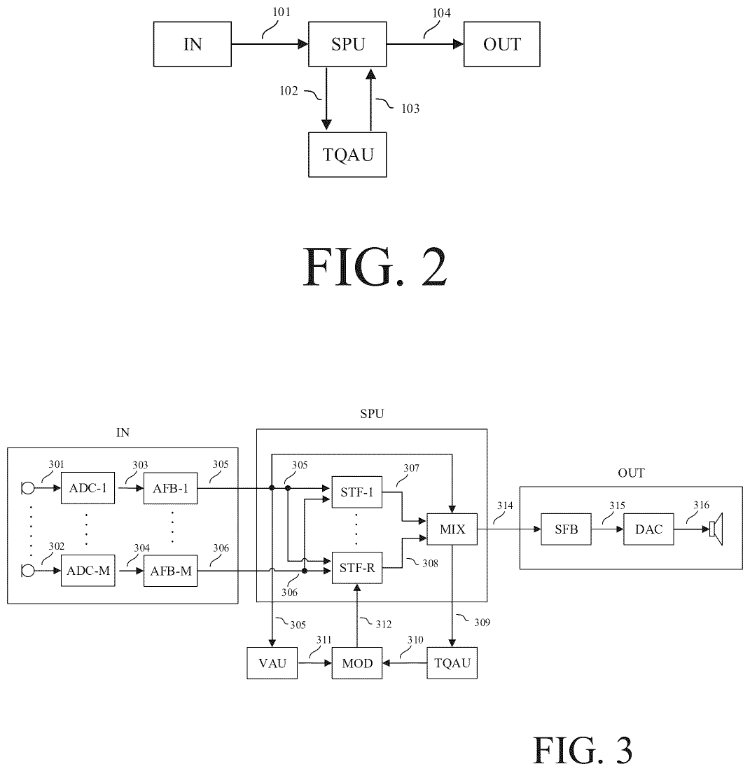

FIG. 2 shows an exemplary block diagram of a hearing aid comprising an input unit IN. The input unit IN comprises an input transducer, e.g. a microphone, configured to pick-up sound. The input transducer may be placed on the hearing aid shell. The input unit IN provides the electrical audio input signal 101. The hearing aid comprises a signal processing unit SPU configured to receive the electrical audio input signal 101 and provide a processed signal 102. The hearing aid comprises a target quality assessment unit TQAU configured to receive the processed signal 102 and determine an assessment value 103 based on an audio parameter, wherein the audio parameter is a speech-like value. The signal processing unit SPU receives the assessment value and determines an output signal 104 based on the assessment value. The output signal is received by the output unit OUT which outputs the output signal.

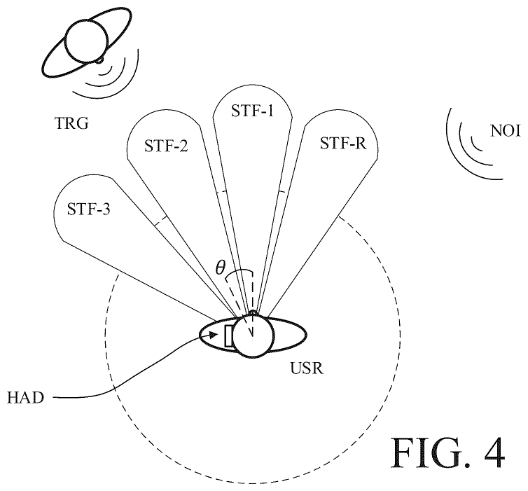

FIG. 3 shows an exemplary block diagram of a first embodiment of a hearing aid based on the present disclosure. The hearing aid comprises an input unit IN comprising a plurality of input transducers, e.g. a plurality of microphones, configured to pick-up sound. The input unit IN provides a plurality of input transducer output signals 301, 302, each for providing an input transducer output signal (x₁(t), . . . , x_{M}(t)) representative of a sound signal. Each input transducer output signal is received by an analogue-to-digital converter ADC-1, . . . , ADC-M configured to digitalize each input transducer output signal and provide time-domain digitalized input signals 303, 304 denoted as xₘ(n) for m=1,2, . . . , M, where the variable n represents the discrete-time variable. The variable M represents the number of input transducers. The time-domain digitalized input signals 303, 304 are each received by an analysis filter bank AFB-1, . . . , AFB-M to transform the time-domain digitalized input signals 303, 304 to the time-frequency domain and provide a time-frequency domain input signal 305, 306 represented by the variable Xₘ(k, l) for m=1, 2, . . . , M where the variable k=1, 2, . . . , K represents the frequency band index of the TF domain input signal and K represents the total number of frequency bands. The variable l∈ [symbol] ( [symbol] refers to the number set of integers) represents the frame index of the TF domain input signal. In this embodiment, the time-frequency domain input signals 305, 306 represent a plurality of electrical audio input signals.

The hearing aid comprises a signal processing unit SPU receiving the time-frequency domain input signals 305, 306. The signal processing unit SPU comprises a plurality of filters STF-1, . . . , STF-R each filter comprises a beamformer configured to steer towards a pre-defined location. The filters are implemented in the TF domain with a plurality of filters for each frequency band, hence the total number filter bank is R×K, i.e., there are R number of filters for each K number of frequency bands. The filters use filter weights denoted as denoted as W_{m,r}(k, l)∈ [symbol] where the subscripts m represents the microphone index and r=1, 2, . . . , R represents the r'th filter. The beamformers for each frequency band are configured steer towards different directions. For example, the filter, r=1 [w_{1,1}(k, l), w_{2,1}(k, l) . . . , w_{M,1}(k, l)], may be configured to be steered towards the frontal direction of a user wearing the hearing aid, i.e. an angle of 0°, and the filter, r=1 [w_{1,2}(k, l), w_{2,2}(k, l) . . . , w_{M,2}(k, l)], may be configured to be steered towards an angle of 45°, etc. The output of each filter is a linear combination of the TF domain signal Xₘ(k, l) using the filter weights described as:

$${Y}_{r} ( k , l ) = {\sum }_{m = 1}^{M} {w}_{m , r}^{*} ( k , l ) \cdot {X}_{m} ( k , l ) ,$$

where Yᵣ(k, l) represents the filtered signal at frequency bin k and time frame l. The superscript * represents the complex conjugate. The filtered signals 307, 308 are received by a mixing unit MIX. The mixing unit MIX comprises a plurality of linear combinations of the filtered signals 307, 308 and the electrical audio input signal 305. The mixing unit comprises a first set of mixing factors denoted as a_{r,i}(k) where i=1, 2, I.,I and r=1, 2, . . . , R. The first set of mixing factors may be pre-defined values determined by a hearing care specialist or the hearing aid manufacturer. The first set of mixing factors is used to combine the filtered signals 307, 308 and provide a combined filtered signal. The mixing unit comprises a second set of mixing factors denoted as βₚ(k) where p=1, 2, . . . , P. The second set of mixing factors may be pre-defined values determined by a hearing care specialist or the hearing aid manufacturer. The second set of mixing factors is used to combine the combined filtered signal and the electrical audio input signal 305 to provide a plurality of mixed signals 309. The mixed signals may be described as:

$${S}_{i , p} ( k , l ) = ( 1 - {β}_{p} ( k ) ) \cdot {\sum }_{r = 1}^{R} {α}_{r , i} ( k ) \cdot {Y}_{r} ( k , l ) + {β}_{p} ( k ) \cdot {X}_{1} ( k , l ) ,$$

where

$$z = {\sum }_{r = 1}^{R} {α}_{r , i} ( k ) \cdot {Y}_{r} ( k , l )$$

is the combined filtered signal and (1−βₚ (k))·z+βₚ(k)·X₁(k, l) is the mixed signal 309 using the i'th first set of mixing factors and the p'th second set of mixing factors. The numerical range of the mixing factors βₚ(k) is configured to be βₚ(k)∈[0,1] such that when βₚ(k)=0, the mixed signals 309 comprise only the electrical audio input signal 305, and when βₚ(k)=1, the mixed signals 309 comprise only the combined filtered signal, and when βₚ(k)=0.5, the mixed signals comprise half the amount of the electrical audio input signal 305 and half amount of the combined filtered signal. X₁(k, l) denotes the electrical audio input signal 305 based on the front microphone of a behind-the-ear hearing aid. The processing parameters being constituted by the filter weights and the mixing factors. The mixed signals are the processed signals 309. The hearing aid comprises a target quality assessment unit TQAU producing an assessment value g_{i,p} 310 for each processed signal 309. The target quality assessment unit TQAU is represented by the function G(·). In this embodiment, the function G(·) is constituted by a neural network trained to determine a speech-likeness value for each processed signal 309. The target quality assessment unit TQAU receives processed signals 309 and produces the assessment values g_{i,p} 310 for all i and p. The target quality assessment unit TQAU outputs a plurality of assessment values 310, each being represented as:

$${g}_{i , p} = G ( {S}_{i , p} ) for all i and p ,$$

Where g_{i,p} 310 represents the speech-likeness value and S_{i,p} 309 represents a time-frequency part or segment of S_{i,p} (k, l). If S_{i,p} 309 resembles a speech-like signal, the assessment value g_{i,p} 310 is ‘1’ or a value close to ‘1’. If not, the assessment value g_{i,p} 310 is ‘0’ or a value close to ‘0’. The hearing aid comprises a modification unit MOD receiving the plurality of assessment values 310. The modification unit MOD is configured to search for the indices of i and p of resulting in the highest assessment value g_{i,p} 310. The hearing aid further comprises a voice activity unit VAU configured to provide a voice activity detection value 311, where the voice activity detection value 311 indicates the presence of speech in the electrical audio input signal 305. The voice activity detection value 311 is used to determine the activation or deactivation of the modification unit MOD such that when the modification unit MOD is activated, i.e. when speech is present in the electrical audio input signal 305, then the output of the modification unit MOD is represented as:

$${i}^{⋆} , {p}^{⋆} = arg {max}_{i , p} {g}_{i , p} ,$$

where the variables i* and p* denote the index i and index p that produce the highest assessment value 310. When the modification unit MOD is deactivated, i.e. when speech is absent in the electrical audio input signal 305, then the modification unit MOD provides the previous values of i* and p* 312. The signal processing unit SPU receives the indices i* and p* 312 and determines the output signal 314 as the mixed signal with indices i* and p* i.e.:

$$E ( k , l ) = {S}_{{i}^{⋆} , {p}^{⋆}} ( k , l ) ,$$

where E(k, l) is the output signal 314. The hearing aid comprises an output unit OUT receiving the output signal 314. The output unit OUT comprises a synthesis filter bank SFB to transform the output signal into the time-domain as a time-domain output signal 315. The output unit OUT comprises a digital-to-analog converter DAC receiving the time-domain output signal 315 and is configured to convert the time-domain output signal into an analogue output signal 316. The output unit comprises an output transducer, e.g. a loudspeaker, configured to produce an output sound based on the analogue output signal 316.

In a second embodiment, the signal processing unit SPU comprises a filter for each frequency bin. The filters are adaptive, i.e., the filter weights used by the filters are time-varying. The weights of the adaptive filters are denoted as wₘ(k, l)∈ [symbol] . Each filter STF comprises a linear combination of the electrical audio input signal 305, 306 and can be described as:

$$Y ( k , l ) = {\sum }_{m = 1}^{M} {w}_{m}^{*} ( k , l ) \cdot {X}_{m} ( k , l ) ,$$

where Y(k, l) is the filtered signal. The filtered signal is received by the mixing unit MIX which is configured to combine the filtered signal with the electrical audio input signal X₁(k, l) using the mixing factor β(k, l) to determine the mixed signal given as:

$$S ( k , l ) = ( 1 - β ( k , l ) ) \cdot Y ( k , l ) + β ( k , l ) \cdot {X}_{1} ( k , l ) ,$$

where G_{MIX}(·) is the function of the mixing unit MIX the algorithm used for the mixing unit MIX. The filter weights and the mixing factors are configured to be adaptive, i.e. change over time (i.e. frame). The filter weights of the filter and the mixing factors are stacked into a parameter vector given as Θ(k, l)=[w₁(k, l), . . . , w_{M}(k, l), β(k, l)]^{T} where T denotes the transposition of a vector. The parameters in the parameter vector Θ(k, l) are modified by maximizing (or minimizing) a cost function.

The processed signal being the mixed signal in this embodiment. The hearing aid in the present embodiment FIG. 4, comprises a target quality assessment unit TQAU producing an assessment value g. The target quality assessment unit receives the processed signal time-frequency segment of S(k, l) and determines the assessment value g. The target quality assessment unit TQAU is further configured to provide the assessment value g for each frame l. If the time-frequency segment of S(k, l) resembles a speech signal, the assessment value g is ‘1’ or close to ‘1’. If not, the assessment value g is ‘0’ or close to ‘0’. The assessment value may also be interpreted as a speech presence probability, i.e., a value of 0.8 indicates an 80% chance of speech presence and a value of 0.2 indicates a 20% chance of speech presence. The functional description of signal processing unit SPU including the target quality assessment unit TQAU can be described using G(X) which includes the filters, the mixing unit, and the target quality assessment unit. The hearing aid further comprises a modification unit MOD configured to modify the processing parameters used by the signal processing unit SPU constituted by the filter weights and mixing factors. The modification unit MOD comprises a cost function used to determine the dispersion between a desired assessment value T and the determined assessment value g. The desired assessment value T is ‘1’ when a desired speech signal is present in the electrical audio input signals. In this embodiment, the modification unit MOD comprises a cost function based on the binary cross-entropy function, which for an observation of g is given as:

$$H ( g , T ) = - ( T \cdot log ( g ) + ( 1 - T ) \cdot log ( 1 - g ) ) .$$

The modification unit MOD can be configured to receive the current assessment value and past assessment values to compute an average cost given as:

$$H ( {g}_{1} , … , {g}_{J} , {T}_{1} , … , {T}_{J} ) = - \frac{1}{J} {\sum }_{j = 1}^{J} ( {T}_{j} \cdot log ( {g}_{j} ) + ( 1 - {T}_{j} ) \cdot log ( 1 - {g}_{j} ) ) .$$

The hearing aid further comprises a voice activity unit VAU comprising a voice activity detector algorithm. The voice activity unit VAU determines if a speech signal is present in the electrical audio input signal. The desired assessment value T used by the modification unit MOD is the output of the voice activity unit VAU. The output of the voice activity unit VAU is binary where a value of ‘1’ indicates speech presence. The modification unit MOD uses the desired assessment value T from the voice activity unit VAU, the assessment value g from the target quality assessment unit TQAU, and cost function to determine partial derivatives for each parameter of the parameter vector Θ(l). The partial derivative of a function with respect to the parameter θ is denoted as ∂/∂θ. The gradient of a multivariate function is denoted with the symbol ∇ where ∇=[∂/∂θ₁, . . . , ∂/∂θ_{Q}] where Q is the total number of parameters of the cost function, hence the gradient is a stacked vector of partial derivatives of a function. The modification unit MOD determines the parameters used by the signal processing unit SPU by using the gradient of the cost function H(g, T) in a gradient descent or ascent algorithm to minimize the cost function by updating the parameters of the signal processing unit SPU. The modification step can be described as:

$$Θ ( l + 1 ) = Θ ( l ) - a {∇}_{Θ} H ( g , T ) ,$$

where a is the step-size of the gradient descent algorithm. Likewise, the modification unit MOD can be configured to use multiple observation of the assessment value g such that:

$$Θ ( l + 1 ) = Θ ( l ) - a {∇}_{Θ} H ( {g}_{1} , … , {g}_{J} , {T}_{1} , … , {T}_{J} ) .$$

The gradient descent algorithm is further configured to only run the update step in situations where the speech is detected present by the voice activity unit VAU in the electrical audio input signal. The backpropagation algorithm is used to determine each partial. In this embodiment, the output signal is based on the processed signal using the modified processing parameters. Alternatively, the output signal is based on the processed signal before using the modified processing parameters. The hearing comprises an output unit OUT comprising a synthesis filter bank SFB to provide a time domain output signal. The hearing aid comprises a digital-to-analog converter DAC configured to receive the time domain output signal and provide an analogue output signal. The hearing aid comprises an output transducer configured to produce an output sound based on the analogue output signal.

FIG. 4. Shows an illustration of beampatterns of the plurality of filters described in the embodiment of FIG. 2. The illustration further shows a situation of a hearing aid user USR wearing a hearing aid HAD on the left ear. The situation comprises a target sound TRG generated by a target speaker and a noise signal NOI generated by a noise source. The sound reaching the hearing aid is a noisy sound based on a combination of the target sound TRG and the background noise signal NOI. The beampatterns generated by the filters are illustrated as STF-1, . . . , STF-R. STF-1 is the beampattern corresponding to the filter STF-1 in FIG. 2. Each filter is configured to be steered towards different directions. For example, the filter STF-1 is configured to be steered towards the frontal direction relative to the hearing aid user, and the filter STF-2 is configured to be steered towards direction θ as shown in FIG. 3.

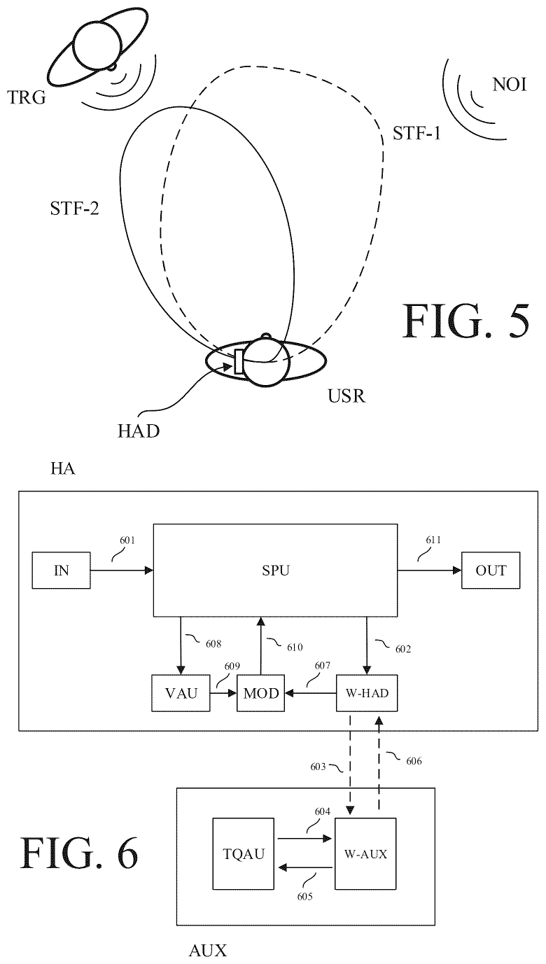

FIG. 5 shows an illustration of the beampatterns provided by the adaptive filter described in the second embodiment of FIG. 3. The situation comprises a target sound TRG provided by a target speaker and background noise NOI provided by a noise source. The sound reaching the hearing aid is a noisy sound signal based on a combination of the target sound TRG and the background noise NOI. The first beampattern STF-1 shows the beampattern using the current processing parameters. The second beampattern STF-2 shows the beampattern using the modified processing parameters. The first beampattern STF-1 being towards the front of the user USR instead of towards the target sound. This may result in a lower assessment value compared to a filter being steered towards the target sound. As illustrated in FIG. 5, using the modified processing parameters results in a beampattern STF-2 steered more towards the target speaker, hence achieving an improved assessment value.

FIG. 6 shows an exemplary embodiment of a hearing aid system comprising a hearing aid HAD and an auxiliary device AUX. The auxiliary device AUX comprises a target quality assessment unit TQAU and a first wireless communication unit W-AUX. The hearing aid HAD comprises an input unit IN, an output unit OUT, a voice activity unit VAU, a modification unit MOD, a signal processing unit SPU, and a second wireless communication unit W-HAD. Sound is picked-up by the input unit IN and provides an electrical audio input signal 601 The signal processing unit SPU receives the electrical audio input signal 601. The signal processing unit SPU provides a processed signal 602 based on the electrical audio input signal 601. The second wireless communication unit W-HAD receives the processed signal 602 and provides a wireless processed signal 603 based on the processed signal 602. The first wireless communication unit W-AUX receives the wireless processed signal 603 and provides the processed signal 604 on the auxiliary device AUX. The target quality assessment unit TQAU receives the processed signal 604 and determine an assessment value 605 indicative of the presence of clean speech in the processed signal 604. The first wireless communication unit W-AUX receives the assessment value 605 and provides a wireless assessment value 606 which is received by second second wireless communication unit W-HAD. The second wireless-communication unit W-HAD provides the assessment value 607 and is received by the modification unit MOD. The voice activity detection unit VAU receives the electrical audio input signal 608 and determines a voice activity detection value 609 indicative of speech in the electrical audio input signal 609. The modification unit determines a modified processing parameter 610 based on the voice activity detection value 609 and the assessment value 607. The signal processing unit SPU uses the modified processing parameter 610 and determines an output signal 611 received by the output unit OUT.

It is intended that the structural features of the devices described above, either in the detailed description and/or in the claims, may be combined with steps of the method, when appropriately substituted by a corresponding process.

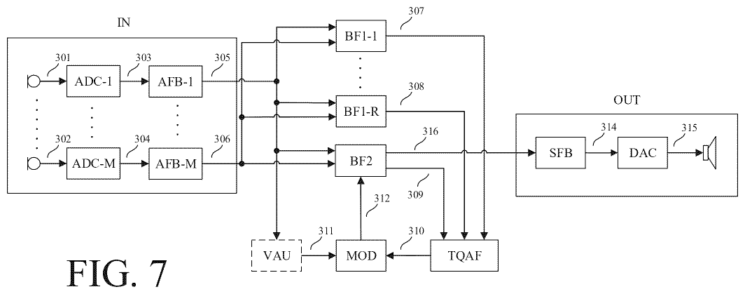

FIG. 7 shows an exemplary embodiment of a hearing aid according to the present disclosure. The input unit IN and the output unit OUT corresponds to that explained in conjunction with the embodiment shown on FIG. 3. The hearing aid comprises a plurality of first beamformers BF1-1 . . . . BF1-R configured to provide a plurality of first beamformed signals 307, 308 based on the electrical audio input signals 305, 306. Each of the first beamformers, 307, 308 are configured to be steered towards different fixed directions, same principle as seen and explained in conjunction with FIG. 4. Each of the first beamformers 307, 308 is associated with a different first processing parameter. The hearing aid comprises a second beamformer BF2 configured to provide a second beamformed signal 309 based on the electrical audio input signals 305, 306 and a second processing parameter. A directionality of the second beamformed signal 309 is determined to maximize an assessment value. The hearing aid comprises a target quality assessment function TQAF configured to determine a plurality of assessment values based on the plurality of first beamformed signals 307, 308 and the second beamformed signal 309. The target quality assessment function TQAF may be configured to receive the plurality of first beamformed signals 307, 308 and the second beamformed signal 309 and determine an assessment value for each signal. The hearing aid comprises a modification unit MOD configured to modify the second processing parameter based on the assessment values. The hearing aid comprises output unit OUT configured to output an output signal 315 determined based on a modified second processing parameter. The plurality of first beamformers BF1-1 . . . . BF1-R may be minimum power distortion-less response beamformers or minimum variance distortion-less response beamformers. The modification unit MOD may be configured to determine a partial derivative with respect to the second processing parameter of the target quality assessment function TQAF based on the highest assessment value, and wherein the modification unit is configured to modify the second processing parameter based on the partial derivative. The modification unit MOD may comprise a gradient descent algorithm configured to modify the second processing parameter based on the partial derivative and a previous estimate of the second processing parameter. The modified second processing parameter may be determined as the first processing parameter or the second processing parameter associated with the highest assessment value. The assessment values may be indicative of one or more of the following: a speech-likeness, a speech intelligibility, a voice activity, a speech quality. The target quality assessment function TQAF may be a neural network trained to determine the assessment values. The target quality assessment function TQAF is a signal-to-noise ratio function and wherein the assessment values are indicative of signal-to-noise ratios. The hearing aid may comprise a voice activity unit VAU configured to determine the presence or absence of a speech signal based on the electrical audio input signal 305 and provide a voice activity signal 311. The modification unit MOD may be configured to modify the second processing parameter if the voice activity signal is indicative of the presence of speech.

The claims are not intended to be limited to the aspects shown herein but are to be accorded the full scope consistent with the language of the claims, wherein reference to an element in the singular is not intended to mean “one and only one” unless specifically so stated, but rather “one or more.” Unless specifically stated otherwise, the term “some” refers to one or more.

1. A hearing aid comprising:
an input unit configured to provide an electrical audio input signal representing a sound:
a plurality of first beamformers configured to provide a plurality of first beamformed signals based on the electrical audio input signal, wherein each of the first beamformers is configured to be steered towards different fixed directions, and wherein each of the first beamformers is associated with a different first processing parameter:
a second beamformer configured to provide a second beamformed signal based on the electrical audio input signal and a second processing parameter, wherein a directionality of the second beamformed signal is determined to maximize an assessment value:
a target quality assessment function configured to determine a plurality of assessment values based on the plurality of first beamformed signals and the second beamformed signal;
a modification unit configured to modify the second processing parameter based on the assessment values; and
an output unit configured to output an output signal determined based on a modified second processing parameter.

2. A hearing aid according to claim 1, wherein the plurality of first beamformers are minimum power distortion-less response beamformers or minimum variance distortion-less response beamformers.

3. A hearing aid according to claim 1, wherein the modification unit is configured to determine a partial derivative with respect to the second processing parameter of the target quality assessment function based on the highest assessment value, and wherein the modification unit is configured to modify the second processing parameter based on the partial derivative.

4. A hearing aid according to claim 3, wherein the modification unit comprises a gradient descent algorithm configured to modify the second processing parameter based on the partial derivative and a previous estimate of the second processing parameter.

5. A hearing aid according to claim 4, wherein the modified second processing parameter is determined as the first processing parameter or the second processing parameter associated with the highest assessment value.

6. A hearing aid according to claim 1, wherein the assessment values are indicative of one or more of the following: a speech-likeness, a speech intelligibility, a voice activity, a speech quality.

7. A hearing aid according to claim 1, wherein the target quality assessment function is a neural network trained to determine the assessment values.

8. A hearing aid according to claim 1, wherein the target quality assessment function is a signal-to-noise ratio function and wherein the assessment values are indicative of signal-to-noise ratios.

9. A hearing aid according to claim 1, wherein the hearing aid comprises a voice activity unit configured to determine the presence or absence of a speech signal based on the electrical audio input signal and provide a voice activity signal, and wherein the modification unit is configured to modify the second processing parameter if the voice activity signal is indicative of the presence of speech.

10. A method for providing an output signal, the method comprising:
providing, by an input unit, an electrical audio input signal representing a sound;
providing, by a plurality of first beamformers, a plurality of first beamformed signals based on the electrical audio input signal, and wherein each first beamformer is configured to be steered towards different fixed directions, and wherein each of the first beamformers is associated with a different first processing parameter;
providing, by a second beamformer, a second beamformed signal based on the electrical audio input signal and a second processing parameter, wherein a directionality of the second beamformed signal is determined to maximize an assessment value;
determining, by a target quality assessment function, a plurality of assessment values based on the plurality of first beamformed signals and the second beamformed signal;
modifying, by a modification unit, the second processing parameter based on the assessment values; and
outputting, by an output unit, an output signal determined based on a modified second processing parameter.
